(19) United States
(12) Patent Application Publication
(10) Pub. No.: US 2005/0033653 A1
(43) Pub. Date: Feb. 10, 2005

(54) Electronic mail card purchase verification

(76) Inventors: Ian Eisenberg, Seattle, WA (US); Ched Switzer, Seattle, WA (US); Brian Marchlewicz, Seattle, WA (US)

Correspondence Address: John P. Luther;Newman & Newman, LLP, Suite 610, 505 Fifth Avenue South, Seattle, WA, 98104, US

(21) Appl. No.: 10/637,315

(22) Filed: Aug. 7, 2003

(51) Int. Cl. G06F 17/60

(52) U.S. Cl. 705/26

(57) ABSTRACT

The present invention provides a selectively tailored product, method, apparatus, and method of conducting an online vending business comprising an authorization method for electronic purchase transactions. In this invention, a user or would-be purchaser at a terminal, for example, a remote terminal, which may be a telephone or a personal computer, attempting to consummate an electronic purchase transaction at a merchant vendor's online address by presenting, or otherwise inputting, information from a money-transaction card, such as a credit card, actuates or prompts, or causes to be prompted, a probe means, such as an executable computer program, which is effective to seek out and identify various information in an authorization process, inclusive of originating IP address, system local language usage customs, time and date in the local time zone, geographical location, or any other verification information deemed useful to authentication and determination of authorization of the transaction.

### FIELD OF THE INVENTION

This invention relates generally to a method, product, apparatus, and a method of conducting business thereby, of consummating business transactions comprising money transfer, and particularly to a method and product for countering fraud associated with on-line, telephonic and any card-not-present electronic product and/or service purchase transactions, especially as between remotely located parties.

### BACKGROUND OF THE INVENTION

As product and services purchases through Internet sources, or through other remote arenas, have increased in recent years, so has the incidence of fraudulent transfer activities. This has occurred to a great degree through unauthorized transactional card, e.g. credit/debit card, usage, and particularly in card-not-present transactions in mail/Internet order and telephone order transactions, which have a higher fraud rate than face-to-face transactions.

In typical money-transfer transactional card sales, a customer visits a site, for example, an Internet site, or a retailer or other provider of goods and/or services, and normally initiates the purchase process by completing and submitting a form which may contain, inter alia, the user's name, billing address, zip code, telephone number and, of course, money transactional card number, usually with its expiration date, and other verification information, such as Credit Code Value (CCV), or Visa's Card Verification Value (CVV) or MasterCard's Card Validation Code (CVC). Upon confirmation of the authenticity of the card and/or authorization for its use, products or services, as the case may be, are then transferred or otherwise made available to the would-be purchaser. As is known, such transactional scenarios are rife with undetected unauthorized transactional card usage, stolen cards or card information. Detection of such fraud is hampered by increased remoteness between purchasers of goods or services and vendors. For example, when a card's magnetic stripe is read at a point of sale terminal, a CVV or CVC can be verified during authorization. However, when the card is not present, the CVV or CVC cannot be validated. To help reduce fraud in a card-not-present environment, CVV2/CVC2 security codes have been implemented in conjunction with card usage. These numbers are usually printed near the signature panel of cards. In remote transactions, card-not present merchants are to ask the putative cardholder to read the code from the card, and the merchant then asks for a CVV2/CVC2 verification during authorization, and the issuer (or processor) validates the codes and relays decline/approve results. It is thought that merchants, by using CVV2/CVC2 results along with Address Verification Service (AVS), can make more informed decisions about whether to accept transactions. However, these measures can be easily avoided by the holder of stolen information, such as a stolen card, with security code information and the use of proxy ID address(es).

Various other methods said to combat fraudulent card transaction use have been reported in recent years. For example, published International Application WO 96/39769 (PCT/US96/04603) to Rodwin discloses an apparatus and method for providing unique identifiers to remote dial-in network clients. In this system, a remote user at a remote computer dialing into a computer network accesses the computer network by way of a remote access device which is coupled to the network. The remote access device receives a request from the remote computer for an identifier, and in response generates a client identifier that is said to uniquely identify the remote computer, and thereafter providing such unique client identifier to the remote computer. The unique client identifier is described as generated by the two items: (1) a hardware-level address associated with the remote access device, such as the Medium Access Control address (MAC) on a network interface card that the remote access device uses to couple to the network; and (2) the current date and time said to be preferably derived from an on-board Real Time Clock clip in the remote access device. As further described in this method, as the MAC address of a node coupled to the network is globally unique to the network, and in the world, and because the date and time is unique at any particular instant, the concatenation of these two features is expected to yield a globally unique identifier. This system falls short, however, of identifying unauthorized money-transaction card usage at remote locations, as the IP address of the so-called remote user, the original address of a fraudulent purchaser, can easily be masked by way of proxy servers inter-displaced between the fraudulent purchaser's address and a transaction processor associated with a vendor.

Another example of a system based on remote computer identification is that disclosed in European Patent Application EP 1 039 724 A2 of a method and apparatus for storage of user identifier/IP address pairs in a network. This system is said to include a Dynamic Host Configuration Protocol (DHCP), an Internet protocol for automating the enablement of individual computers on an IP network to extract configurations from a server(s) that do not have exact information about an individual computer until information is required. In this system, a DHCP server assigns IP addresses to the computer and other devices in the network. A computer receives an IP address from the DHCP server, and includes an authentication server coupled with a device for receiving user identifier/IP address pairs, and authenticating the user. Again, however, such a system is easily circumvented by an un-authorized card transaction holder by the use of one or more proxy servers.

In U.S. Patent Publication No. 2002/0029190 A1 (Mar. 7, 2002) to Gutierrez-Sheris, web-based money-transfer techniques are discussed. Here, a financial institution employs a web-based server for use in transferring money between a customer and a beneficiary where the server undertakes on-line money transfer services via the Internet and the Public Switched Telephone Network (PSTN). As described, a customer opens a transaction web page (i.e. payor page) provided by the server, and inputs transaction data into the payor page, which can include a sum of money, customer and beneficiary data, basic payment data and credit-card information, except a credit card number. All of the transaction data is sent to the server via the Internet, which is confirmed in a second web page, afterwhich the server instructs the customer to contact the financial institution via the customer's telephone. Upon receiving the customer's telephone call, the server then looks for a match between the received automatic number identification (ANI) signal and the telephone number provided by the customer. If authenticated, the customer then enters the credit card number, and in return receives a fund-pick-up number in an audio message which is provided to the beneficiary to use in collecting funds.

While this system is somewhat burdensome in requiring several tasks to be undertaken to consummate a trsaction, it is unreliable authentication-wise, as it is also prone to fraudulent manipulation by proxy IP address, and proxy telephone number location.

In yet another example, U.S. Pat. No. 6,122,624 is said to disclose a method and system for enhanced fraud detection in electronic purchase transactions from remote sites. In this system, a user at a remote terminal attempting to conduct an electronic purchase is requested, for example, at a payor page on an Internet web site via a personal computer, or a telephone, to input the user's billing address and social security number, which is used to verify the billing address of the user. The inputted Social Security number is communicated to a local account database containing information about customers, as identified by their Social Security number, and determinations made as to whether the account associated with the particular inputted Social Security number has been authorized for use. In cases where the inputted Social Security number has been blocked due to past fraudulent use, or access to use is not further permitted for some other reason, e.g. account threshold exceeded, authorization for a purchase is refused.

Additional safeguards include a determination as to whether the account associated with the inputted Social Security number has been in a local account database for longer than a predetermined period of time, or if the account has been in existence for longer than a predetermined period. In such cases, as disclosed, a further determination is made to ensure that the input address corresponds to an address stored in the local account database, as identified by the Social Security number. If the address is a match, or the account has been in the local account database for less than a predetermined period of time, then authorization for a purchase is approved.

In another safeguard disclosed in this system, prior to accessing a central Social Security number database, an automated transaction processing system may collect the phone number from which the remote terminal is communicating. This phone number is then compared with a stored list of blocked phone numbers that are not authorized to perform purchase transactions. As in other examples cited above, however, this method may be easily circumvented by stolen personal identification data, such as provided by a stolen wallet containing a money-transaction card and Social Security number information, often times contained in a stolen driver's license, and other address information and the like, and the use of any number of proxy IP locations.

Aside from those identification-based fraud deterrent examples set out above, and similar fraud deterrent systems, the use of Automated Identification Blocking (AIB) to prevent fraudulent electronic purchase transactions has suffered from some basic drawbacks. As many electronic transactions are preformed from some remote terminal connected through telephone lines, a vendor often times will record, or will automatically do so, the telephone number associated with the telephone line of the remote device from the telephone carrier. The vendor possesses a stored list of telephone numbers associated with fraudulent use, which is compared with the ANI to determine if a match exists. If the collected ANI is on the stored list, the telephone line is blocked from further use. However, as is known, ANI blocking is only effective in preventing continued fraudulent usage from a particular phone number. It can become a serious business impediment as it labels a telephone number used on only one occasion, perhaps as a proxy in the case of a fraudulent transaction, as a blocked phone number. The telephone number and the purchaser's billing address on, say, a fraudulent would-be purchaser's IP address, may not be interrelated, but the telephone number will be blocked from any further purchase transactions nevertheless. Thus, the next attempted purchase transaction using that telephone number may be a valid transaction, but blocked and denied all the same as the telephone number has been blocked by non-discriminatory ANI blocking. As can be seen, remote terminals frequently having a plurality of different users, and many possible new or repeat customers, such as pay phones, business or hotel telephones, will be blocked by ANI blocking by one bad actor on a onetime use thereby preventing a host of future valid purchase transactions from that one-time ill-used remote terminal.

As shown from such conventional fraud combating techniques there clearly exists a need for a more selective, and effective, method for preventing, or at least substantially hindering, fraudulent electronic purchase transactions from a remote site, and which does not adversely effect or hinder future viable business of a vendor.

### OBJECTS AND SUMMARY OF THE INVENTION

It is a primary object of this invention to remedy the above-identified shortfalls of conventional products and methods, and to provide a selective, more efficient and more effective, method and product for detecting fraud in electronic online purchase transactions from a remote site in which purchasers pay a vendor for purchases by a money-transaction card, such as a credit card, at a site associated with the vendor's Internet address or web page.

Another object of this invention is to provide such a selective and more efficient fraud combating product and method which in turn does not produce deleterious effects upon future legitimate and viable business transactions.

Still another object of the present invention is to provide such a selective product and method for enhanced fraud detection in purchase transactions from a remote site by using identifying data in a manner which cannot be readily detected by the fraudulent user, and which cannot be readily circumvented by such fraudulent user.

It is still a further object of the present invention to make available a method of conducting business selected from an online vending business and/or an online money-transfer card authorization business and/or online credit card transaction business incorporating and using such selective and effective fraud detection products and methods.

These identified objects and advantages of the present invention are achieved by providing a new and novel method and product for authorizing an electronic purchase transaction. In this invention a user at terminal, for example, a remote terminal, which may be a telephone or a personal computer, attempting to consummate an electronic purchase transaction by presenting, or otherwise inputting, information from a money-transaction card, such as a credit card, actuates or prompts, or causes to be prompted, a probe means such as an executable computer program, which is effective to seek out and identify various information in an authorization process, such as originating IP address, system language, time zone, date, geographical location, or any other verification information deemed useful to authentication of the originating and primary IP address and authorization of the transaction.

Such collected information is used to determine authenticity of the purchaser upon which transactional card authorizations are based, instead of erroneous proxy server numbers, addresses, telephone numbers and the like.

Further, by way of the affirmative and selective authentication money-transactional verification method and product of this invention, fraudulent purchasers will be blocked from consummating illicit transactions, instead of blocking off potentially valuable business numbers and addresses.

The present invention as to its manner of operation and further objects and advantages is best understood by reference to the following Detailed Description of Preferred Embodiments accompanied by reference to the Drawings.

### BRIEF DESCRIPTION OF THE DRAWINGS

FIG. 1 is a general schematic view of a typical money-transaction purchase of product or services through an Internet Service Provider (ISP).

FIG. 2 is a general schematic view of an example of fraudulent money-transaction purchase of products or services through proxy usage by local ISP.

FIG. 3 is a schematic view of an embodiment of the inventive verification method and product for identifying fraudulent purchasers.

FIG. 4 is a schematic view of another embodiment of the verification method and product of the invention.

### DETAILED DESCRIPTION OF PREFERRED EMBODIMENTS OF THE PRESENT INVENTION

The present invention provides a product and method, and method of conducting a business thereby, for selective fraud detection in electronic purchase transactions, such as consummated over the Internet through a vendor's web page or payor page for goods or services. As previously described, in accordance with the present invention a user or would-be purchaser at a remote terminal attempting to conduct an online purchase, for example, with a money-transaction device, such as a credit card, at a vendor's web site or Internet payor address, prompts, or otherwise causes to be activated, a probe means which is effective to affirmatively seek out particular information at the would-be purchaser's remote terminal IP address. The term “online” as used herein refers to any Public Packet Switched Network (PPSN), such as, for example, the Internet, and/or any Public Switched Telephone Networks (PSTN). Such information, as relayed back to the vendor, or vendor's financial transaction server, will guide a decision making process as to whether the purchaser's credit card use is authorized, and to accept the card usage in the transaction.

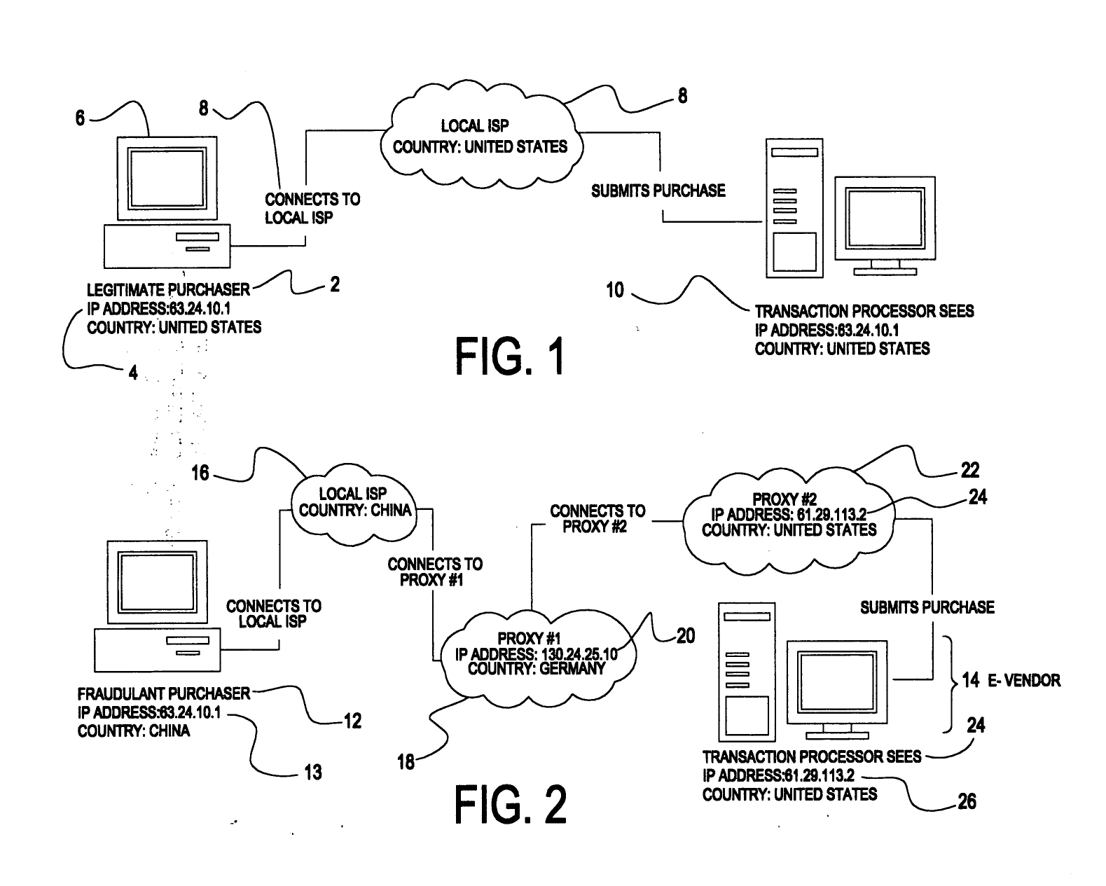

In recent years, identification theft and other fraudulent practices have placed credit cards, and other money transaction devices, into the wrong hands whose unauthorized use goes undetected. Such unauthorized use has been facilitated by using proxy or dummy IP addresses in order to appear to the vendor, or other transaction processor, as a valid authorized use of an electronic money-card transfer, for example, such as the use of a Visa, MasterCard or American Express card. In FIG. 1 there is shown a general schematic view of a typical money-transaction purchase of products or services by electronic means through a local Internet Service Provider (ISP). In initiating the transaction, a legitimate purchaser 2 with an IP address 4 at a remote (or local or otherwise distanced) terminal 6 connects to a local ISP 8. By way of Dynamic Host Configuration Protocol (DHCP), the ISP allocates a unique IP address from a pool of available addresses and assigns it to this connection for this particular session. Purchaser 2 connects to online store or vendor site, selects the items or services for purchase, and submits a purchase order to transaction processor 10. This operation is typically accomplished at a payor page of the vendor or by opening a transaction web page provided by a server 1.

The online store typically gathers such pertinent information from the would-be purchaser as customer billing name and address (BNA), phone number and credit card data and other specific information by way of querying the user's computer for the reported IP address, date and time and language settings. The online store then transmits the collected data to a credit card company directly, or to a billing aggregator or clearinghouse (Authorizing Agent). The Authorizing Agent collects and process this information, and attempts to determine if user-entered data (BNA, phone number, etc.) correlates with information stored in databases specific to the reported credit card number for this transaction.

Based on many qualifying factors, the Authorizing Agent then makes a determination whether to accept or deny this transaction. Reasons for denial of the transaction are commonly that the would-be purchaser is over the limit of his authorized card usage, the card has been reported lost or stolen, or all or part of the purchaser/user's BNA does not match the information stored in the Authorizing Agent's database. Thereafter, the Authorizing Agent transmits back to the online store results as to the success or failure of the transaction, which is reported by the online store to the purchaser. 2 In many instances, when an Internet user contacts an on-line store or catalog to purchase goods or services, such contact will be through the network of an Internet Service Provider (ISP). The purchaser has a fixed IP number assigned to it by the ISP from a “poor” of available IP addresses which the particular ISP owns or leases. The IP address of the initial contact by a would-be purchaser is public knowledge and can be used to determine various information particular to the purchaser. Also, the IP address of the would-be purchasers/user's system can identify a user connecting to the Internet by crosschecking the IP address along with date and time of access with the ISP's user/activity logs and/or database.

Such identification measures, however, are subject to manipulation and circumvention by fraudulent purchasers dispensing false or stolen card transaction information and other personal identification information.

Referring now to FIG. 2, a typical fraudulent transaction is schematically detailed in simplified form. In a session of electronic shopping for goods or services between a fraudulent purchaser 12 and an electronic vendor or entity 14, purchaser 12 in this example is situated in a foreign country and has a unique fraudulent IP address 13. Fraudulent purchaser 12 initiates contact to a local ISP 16, which can be anywhere in the world; in this example “Foreign Country”. Local ISP 16 is associated with fraudulent purchaser IP address 13 (63.24.10.1), the contact initiation point. Local ISP 16 next connects to proxy server 18 (proxy server I herein) which has a new IP address 20 in a different country, such as Gerrnany in this example, and which has as a unique address (130.24.25.10) which is different from the fraudulent purchaser IP address 13. Next, proxy server I connects to proxy server II, 22 which is associated with yet another unique IP address 24, this time, for example, located in the United States and which is different from both fraudulent purchaser IP address 13 and proxy IP address 18.

It is proxy server II 22, with IP address 24, which then submits purchase information to a transaction processor 24 having its own unique IP address 26. As stolen information submitted by fraudulent purchaser 12 to transaction processor 24 to consummate the trasaction, and to receive vendor goods or services, appears legitimate, such as transaction card number, verified IP address including CVV2 and/or CVC 2 information and BNA, phone number, etc., and the like, match authentication data in a database or data store, the fraudulent transaction is erroneously approved.

As discussed above, in a typical operation, the IP address associated with the authorized card user logged in a data store will be compared with a host name provided to a specific user in a specific session in which the purchase transaction was attempted, or in this case, consummated. Oftentimes, a correlation will be carried out to determine the geographical location, i.e. physical or topological location, of a user would/be purchaser from the received ISP DNS IP address, which is input to a system for analysis and correlation with a specific user; whether existing in a store's data store, or new to the store. As the IP address is a fixed address and corresponding ISP identities are readily obtainable, correlation of the location information with the purchase session will enable the determination of a user's location at the time of the session. As can be seen in FIG. 2, the location will be erroneously determined as to be somewhere in the United States, and user geographical location matched to stored data, the money-transaction card authenticated, and all of which perpetuates the fraudulent transaction.

Other conventional technologies available to reduce or combat fraudulent customer-vendor money transactions are known as Secure Sockets Layer (“SSL”) protocol and Secure Electronic Transactions (“SET”). Both of these protocols, which are employed with Internet transactions using existing methods of payment, usually credit card accounts such as Visa®, MasterCard®, and American Express® and the like, rely on mathematical tools or algorithms (“encryption methods”) as unique identifiers to ensure transactional card data will not be intercepted by an unintended recipient, such as an Internet hacker or though a bogus vendor site, and misused in a fraudulent transaction. However, once card information is intercepted, such technologies are still susceptible to fraudulent proxy transactions as depicted in FIG. 2. As also known, both SSL and SET technologies, and other fraud detection methodology, incorporate communication paths that are intended to ensure the integrity of transmissions. These methods are still subject to defeat by a fraudulent purchaser in possession of vital “secure” credit card information, including CW2/CVC2 data, BNA, phone number and other information employing proxy servers, such as in the schematic of FIG. 2, which can set up an apparently acceptable IP address, inclusive of database matching ISP DNS information, and authorized communication paths.

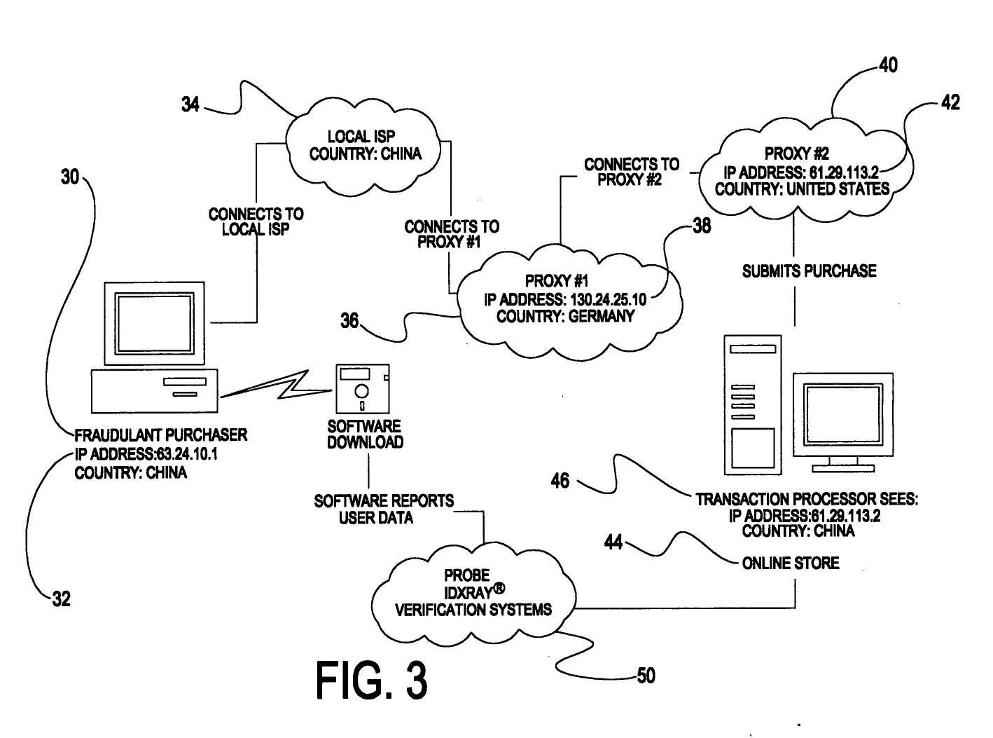

The present invention provides a way to effectively combat fraudulent transactions as shown in FIG. 3 in a selective mode which will not damage possible future transactional sites potentially open to a vendor. Turning now to FIG. 3, there is depicted a general schematic view of a preferred embodiment of the invention, in which a would-be fraudulent purchaser in possession of vital transactional card information is identified and stopped from consummating an electronic fraudulent purchase, whether through the Internet or by telephone system. In FIG. 3, fraudulent purchaser 30, at IP address 32, for example, in some foreign country, such as China in this example, initiates a purchase trsaction by first connecting to a local ISP 34 in the foreign country, for connection to the Internet. By way of DHCP, the ISP allocates the unique IP address 32 from their pool of available address and assigns it to this connection for this particular session. In the communication path, the local ISP 34 connects to a first proxy server I 36, for example, as situated in another foreign country, such as Germany, which has its own unique IP address 38. Next, proxy server I 36 then connects to proxy server II 40 which is situated in the United States and which is associated with its unique IP address 42. As shown, proxy server 140 contacts online store or vendor 44, which is associated with having its own IP address and transaction processor 46, which in this example is the sane country as transaction originating fraudulent purchaser 30, which is China. In accordance with the inventive method, a purchase submission, or other contact with vendor associated transaction processor 44 via fraudulent purchaser IP address, or any proxy address, will initiate or prompt activation of a probe means 50, as discussed below, which is effective to bypass or ignore, or not be affected in any way, by any proxy IP address and to identify and authenticate the originating IP address of fraudulent purchaser 30. Probe means 50 is effective to provide transaction processor 44 with any information desired, such as the location of originating IP address of fraudulent purchaser 30, geographical location of fraudulent purchaser/user 30, language customs at originating IP address, local time zones, local date and time and the like. Any and all of such information can then be used to authenticate card use in the transaction, and to decline the transaction if the card user does not appear to be who she says she is. The method is selective and not detrimental to potential future business as proxy use of various telephone installations will not be blocked, including the specific number used at the originating IP address by a fraudulent purchaser, as the transaction will be declined based on non-matching IP address, geographical data, local date and time, language or other specific grounds.

Turning to FIG. 3 again, the would-be purchaser and user 30 connects to the online store and selects items and/or services for purchase. As described in FIG. 1, the online store then gathers pertinent information from the purchaser 30, inclusive of BNA information, phone number and credit card data information. The online store may also gather user specific information by querying the user's computer for the reported IP address, date and time, and language settings.

In accordance with the present invention, the online store will determine whether would-be purchaser should be “probed”, and to actuate probe means 50, or alternatively, in another embodiment, inventive probe means 50 is automatically actuated upon the purchaser's connection to the online store in most, if not all, transactions as a matter of course.

Thus, in one embodiment of the inventive process and product, the purchaser is prompted upon selection of items and/or services for purchase to confirm their true identity i.e. that which matches what is stored for the credit card authorized use, by accepting a downloadable executable computer program which is probe means 50.

In another embodiment, probe means 50 will automatically be actuated and downloaded, or otherwise prompted, by the purchaser's selection of items and/or services for purchase. As an example in this embodiment it is envisioned that a “click” at a vendor's web page of an item or service for purchase will be combined with a knowing or unknowing acceptance of the downloadable executable probe means 42.

In yet another embodiment, the purchaser may be prompted to confirm their true identity by dialing a Toll-Free Number (TFN) which actuates downloading and implementation of probe means 50, again, either knowingly or unknowingly, by purchaser 30. Probe means 50 is indicated on FIG. 3 as IDXRAY™ Verification Systems™ which contains software executable in probe means 50.

Upon actuation of probe means 50, i.e. when downloaded and executed, it is effective to determine the true IP address of the actual computer attempting to consummate the transaction. By containing the true IP address of the would-be purchaser user, the language settings and the local date and time zone, the system can then, through third party solution, positively identify the physical geographical location of the user, and then securely transmit (e.g. SSL) this encrypted data back to the Authorizing Agent to be utilized in detemming the validity of the transaction.

In another embodiment, if the user chooses, or simply cannot execute the probe means 50, they would then dial the Toll Free Number local to their country/region. By dialing the TFN, the user's phone number is passed to the inventive system by means of Automatic Number Identification (ANI). As a standard in the telecommunications industry, consumers cannot hide their phone number while dialing a TFN. While connected the system quantifies the user's physical geographical location by means of existing third party solutions based upon the ANI reported to the system.

The end result of the forgoing is that the collection of identifying user data is complete and the inventive system now has a collection of unique properties specific to the (remote) user/would-be purchaser. The inventive verification process is complete and the Authorizing Agent now has the invention-provided information (“properties”) which allows them to know exactly where in the world the consumer is physically located and is provided a unique, serialized identifier for this particular consumer.

Once the Authorizing Agent obtains the probe means 50 identified properties for this user, they can then incorporate this data into their systems for determining fraud. In this example the properties reveal that the user is actually physically located in China, and the transaction is therefore determined to be fraudulent and denied.

In another exemplified embodiment of FIG. 3, if the probe means 50-identified properties reveal that the user/purchaser is located where they report they are, and his data matches the information in Authorizing Agent's consumer database, the transaction would probably be approved. In this instance the invention-provided properties through probe means 50 are used to identify and protect an authorized customer and purchaser traveling abroad who is attempting to purchase goods or services online.

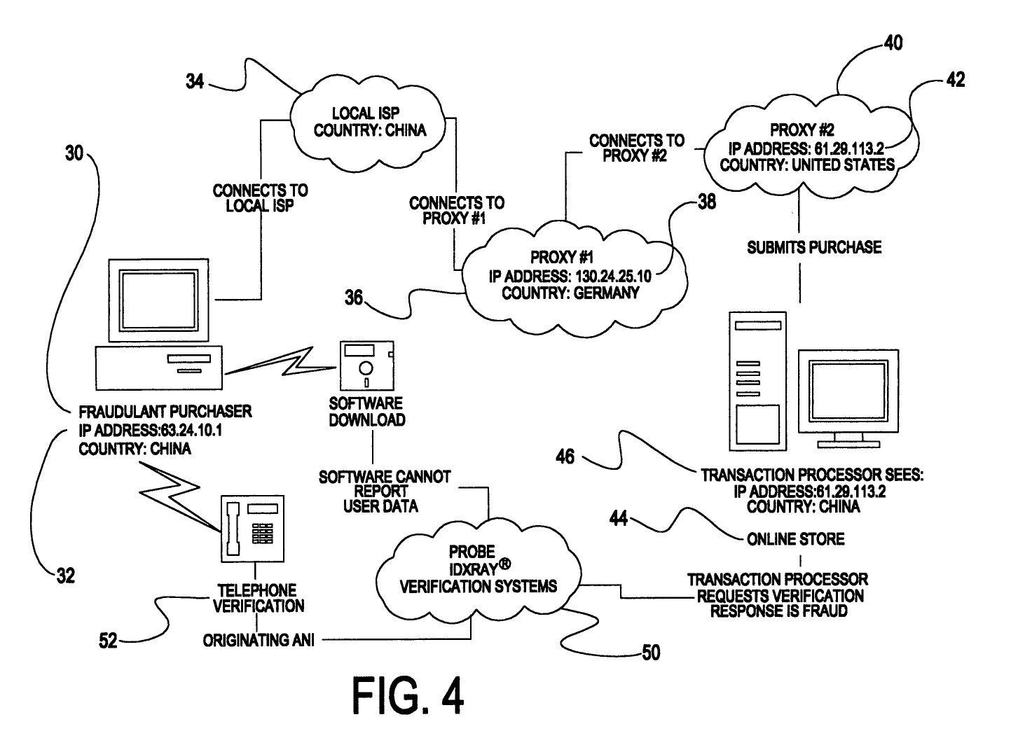

FIG. 4 shows another embodiment of the verification method and product of the present invention. In this example embodiment, probe means 50 is executable by purchaser 30 dialing the TFN, and wherein the number is passed to probe means 50 (IDXRAY™System™) by means of an Automatic Number Identification (ANI), as indicated by 52 in this example. As discussed above, it is conventional in the telecommunications industry that consumers are generally not able to hide their phone number while dialing a TFN. While connected, probe means 50 quantifies the user's physical geographical location by means of existing third party solutions based upon the ANI reported to the system. As in FIG. 3, this operation completes the collection of identifying user data, and the inventive method and product has now compiled a set of unique properties specific to purchaser 30, which allows Authorizing Agent to know the exact geophysical location of purchaser, and to make an informed decision, as in FIG. 3, to deny or authorize the transaction.

The probe means useful in this invention can be a software application, for example, an executable program which is implemented from an Internet browser means or a Java application, or Applet, or from any sensor means or any conventional distribution method.

Another aspect of the invention is an auto-updating function. Periodically, such as a system startup, and initial execution of the application and/or subsequent execution of the probe means executable, the probe means is effective to query a server connected to the Internet to determine if a new version of the probe means executable, or, if an updated probe means, exists. It is contemplated that an environment for this function of the invention can be, for example, the need for determining new IP addresses and the like, or the need for updating any information on a particular purchaser or would-be purchaser, or any information relating to money transfer card use authorization. If it is determined that the probe means executable, or modules of the probe executable, need to be updated, the probe means executable is effective to automatically download and install the updated application or module(s). The user will not be aware that the upgrade process has been activated. After the upgrade has been installed the probe executable will then automatically re-initialize itself ensuring that the client, or online vendor/merchant, has the most recently available version which is installed and active.

In yet another aspect and embodiment of the present inventive electronic mail card purchase verification method, probe means, and apparatus for executing same, if is further contemplated that several business methods may be conducted thereby. Business methods particularly suited to the use of the invention include, of course, any online or telephonic card-not-present business of vending goods or services for sale or lease, or other transaction, and any money transfer card, i.e. credit/debit card authorization business or any financial and/or credit business model.

In any such business method model the present invention may be employed as a stand alone verification method, or used in conjunction with any known conventional fraud combating method or product, including any of those mentioned herein. As will be appreciated, the present invention will be an asset to any business model contemplated.

It will further be appreciated by those persons skilled in the art that the embodiments described herein are merely exemplary of the principles of the invention. While preferred embodiments have been described herein, modification of the described embodiments may become apparent to those of ordinary skill in the art, following the teaching of the invention, without departing from the spirit and scope of the invention as set forth in the appended claims.

1. An authorization method for use in electronic card-not-present purchase transactions comprising,
a. a would-be purchaser at a first Internet Protocol address, or equivalent identification data, accessing a merchant server at a second Internet Protocol, or equivalent identification data, and selecting desired goods and/or services, and placing an order for same with the use of an electronic money-transfer device; and
b. wherein said order placing prompts activation of a probe means which is effective to determine the identity of the first Internet protocol address, or equivalent.

2. The method of claim 1, wherein said probe means is automatically activated by said order placing.

3. The method of claim 1, wherein said probe means voluntarily activated by said would-be purchaser answering and complying with a prompt.

4. The method of claim 1, wherein said probe means is activated by said would-be purchaser placing a prompted telephone call.

5. The method of any of said claims 1 through 4, wherein said probe means is effective to determine, in addition to said first Internet protocol address, information selected from the group consisting of geographic location of said would-be purchaser, the time in the local time zone of the transaction of the would-be purchaser, the date in the time zone of the would-be purchaser's transaction, and language customs usage of the first Internet protocol address.

6. The method of claim 1, wherein said probe means is a software application.

7. The method of claim 1 further comprising basing authorization of transaction determination on information provided by said probe means.

8. The method of claim 5 further comprising basing authorization of transaction determination on information provided by said probe means.

9. A probe means for use in an authorization method for electronic card-not-present purchase transactions comprising,
a. a would-be purchaser at a first Internet Protocol address, or equivalent identification data accessing a merchant server at a second Internet Protocol address, or equivalent identification data, and selecting desired goods and/or services, and placing an order for same with the use of an electronic money-transfer device; and
b. wherein said order placing prompts activation of said probe means which is effective to determine the identity of the first Internet protocol address or equivalent.

10. The probe means of claim 9 wherein said probe means is automatically activated by said order placing.

11. The probe means of claim 9 wherein said probe means is voluntarily activated by said would-be purchaser answering and complying with a prompt.

12. The probe means of claim 9 wherein said probe means is activated by said would-be purchaser placing a prompted telephone call.

13. The probe means of any of said claims 9-12, wherein said probe means is effective to determine, in addition to said first Internet protocol address, information selected from the group consisting of geographic location of said would-be purchaser, the time in the local time zone of the transaction of the would-be purchaser, date of the would-be purchaser's transaction, and language usage customs at first Internet protocol address.

14. The probe means of claim 9, wherein said probe means is a software application.

15. The probe means of claim 13 further comprising basing authorization of transaction determination on information determined by said probe means.

16. Apparatus for carrying out an authorization method for use in electronic card-not-present purchase transactions comprising,
a. a would-be purchaser at a first Internet Protocol address, or equivalent identification data, accessing a merchant server at a second Internet protocol address, or equivalent identification data, and selecting desired goods and/or services, and placing an order for same with the use of an electronic money-transfer device; and
b. wherein said order placing prompts activation of a probe means which is effective to determine the identity of the first Internet Protocol address, or equivalent.

17. The apparatus of claim 16, wherein said probe means is automatically activated by said order placing.

18. The apparatus of claim 16, wherein said probe means is voluntarily activated by said would-be purchaser answering and complying with a prompt.

19. The appartus of claim 16, wherein said probe means is activated by said would-be purchaser placing a telephone call.

20. The apparatus of any of claims 16 through 19, wherein said probe means is effective to determine, in addition to said first protocol address, information selected from the group consisting of the geographical location of said would-be purchaser, the time in the local time zone of the trsaction of the would-be purchaser, the date in the time zone of the would-be purchaser's transaction, and language customs usage at the first Internet protocol address.

21. The apparatus of claim 16 wherein said probe means is a software application.

22. The apparatus of claim 20, further comprising basing authorization of transaction determination on information provided by said probe means.

23. A method of conducting an online vending business, online money transfer card-authorization business or online credit card transaction business comprising the use of an authorization method for use in electronic card-not-present purchase transactions comprising,
a. a would-be purchaser at a first Internet Protocol address or equivalent identification data, accessing a merchant server at a second Internet Protocol address, or equivalent identification data, and selecting desired goods and/or services, and placing an order for same with the use of an electronic money-transfer device; and
b. wherein said order placing prompts activation of a probe means which is effective to determine the identity of said first Internet protocol address, or equivalent.

24. The method of conducting business of claim 23, wherein said probe means is automatically activated by said order placing.

25. The method of conducting business of claim 23, wherein said probe means is voluntarily activated by said would-be purchaser answering and complying with a prompt.

26. The method of conducting business of claim 23, wherein said probe means is activated by said would-be purchaser placing a telephone call.

27. The method of conducting business of any of claims 23 through 26, wherein said probe means is effective to determine, in addition to said first Internet Protocol address, information selected from the group consisting of the geographic location of the would-be purchaser, the time in the time zone of the would-be purchaser's transaction, the date in the time zone of the would-be purchaser's transaction, and the language use customs of the first Internet Protocol address.

28. The method of conducting business of claim 23, wherein said probe means is a software application.

29. The method of conducting business of claim 23, further comprising basing authorization of transaction determination on information provided by said probe means.
